(19) United States
(12) Patent Application Publication
(10) Pub. No.: US 2018/0223030 A1
(43) Pub. Date: Aug. 9, 2018

(54) METHOD FOR PRODUCING FLEXIBLE POLYESTER URETHANE FOAMS WITH INCREASED COMPRESSIVE STRENGTH

(71) Applicant: Covestro Deutschland AG, Leverkusen (DE)

(72) Inventors: Bert KLESCZEWSKI, Koln (DE); Edward BROWNE, Koln (DE); Stephanie GRUNERT, Leverkusen (DE); Mandy VON CHAMIER, Dormagen (DE)

(21) Appl. No.: 15/749,597

(22) PCT Filed: Aug. 3, 2016
(86) PCT No.: PCT/EP2016/068518

§ 371 Date: Feb. 1, 2018

(30) Foreign Application Priority Data
Aug. 4, 2015 (EP) 15179656.2

(51) Int. Cl. C08G 18/18; C08G 18/20; C08G 18/40; C08G 18/42; C08G 18/76

(52) U.S. Cl. CPC C08G 18/1833; C08G 18/2027; C08G 2101/0008; C08G 18/4241; C08G 18/7621; C08G 18/4072

(57) ABSTRACT

The object of the present invention concerns a method for producing flexible polyester urethane foam with increased compression hardness, as well as flexible polyester urethane foam obtainable from the same.

### CROSS-REFERENCE TO RELATED APPLICATIONS

This application is a national stage application under 35 U.S.C. § 371 of PCT/EP2016/068518, filed Aug. 3, 2016, which claims the benefit of European Application No. 15179656.2, filed Aug. 4, 2015, both of which are being incorporated by reference herein.

### FIELD

The object of the present invention concerns a method for producing flexible polyester urethane foams with increased compression hardness as well as the flexible polyester urethane foams available from the same.

### BACKGROUND

Flexible polyurethane (PU) foams are used for a multitude of technical applications throughout industry and for private use, for example for noise insulation, for the production of mattresses, for the padding of furniture and in the automobile industry.

The production of flexible polyester urethane foams normally involves the conversion of di- and polyisocyanates with compounds containing at least two hydrogen atoms that react with isocyanate groups in the presence of propellants and the usual excipients and additives. Flexible polyester urethane foams produced with the usual methods do however have low compression hardnesses of approx. 6 kPa max. according to DIN EN ISO 3386-1. It has not been possible to satisfy demands for higher compression hardnesses to date.

WO 2005/097863 A discloses a method for the production of flexible polyester urethane foams using polymerpolyols in a mixture with compounds with at least two hydrogen atoms that react with isocyanate groups. The method is in particular intended for the production of rigid foams.

There is a great need to produce flexible polyester urethane foams with an increased compression hardness.

### SUMMARY

This task is surprisingly solved with a method for producing flexible polyester urethane foams, obtainable through a reaction of component A, comprising of
A1) 1 to 60 wt. % of a polymerpolyol component comprising at least one polymerpolyol with a hydroxyl value of 10 to 100 mg KOH/g, containing 5 to 50 wt. % of a polymer as a filler and at least one polyetherpolyol as a base polyol and/or at least one polyether carbonate polyol with an ethylene oxide content of 30 to 90 wt. %, 10 to 70 wt. % of propylene oxide and 0 to 35 wt. % of carbon dioxide, each related to the total quantity of propylene oxide, ethylene oxide and carbon dioxide in the polyetherpolyol or polyether carbonate polyol or in their mixtures,
   and
A2) 40 to 99 wt. % of a polyesterpolyol component comprising at least one polyesterpolyol with a hydroxyl value of 30 to 90 mg KOH/g,
   and possibly
A3) one or more groups capable of reacting with isocyanates, which differ from A1 and A2,
   with
B) di- and/or polyisocyanates,
C) water,
D) possibly physical propellants,
E) possibly excipients and additives, such as for example
   a) catalysts,
   b) surfactant additives,
   c) one or more additives selected from the group consisting of reaction inhibitors, cell regulators, pigments, dyes, flame retardants, softeners, fungiastatically and bacteriostatically acting substances, fillers and separating agents.

### DETAILED DESCRIPTION

### Description of Component A:

Component A contains 1 to 60 wt. % of component A1 and 40 to 99 wt. % of component A2, preferably 5 to 50 wt. % of component A1 and 50 to 95 wt. % of component A2, particularly preferably 10 to 40 wt. % of component A1 and 60 to 90 wt. % of component A2.

### Description of Component A1:

Polymerpolyols are understood as containing amounts of solid polymers produced by radical polymerisation of suitable monomers in a base polyol.

The polyetherpolyols and polyether carbonate polyols used as a base polyol have a hydroxyl value according to DIN 53240 of ≥20 mg KOH/g to ≤250 mg KOH/g, preferably of ≥20 to ≤112 mg KOH/g and particularly preferably of ≥20 mg KOH/g to ≤80 mg KOH/g and an amount of ethylene oxide of 30 to 90 wt. % and a propylene oxide amount of 10 to 70 wt. % as well as 0 to 35 wt. % of carbon dioxide, preferably 40 to 80 wt. % of ethylene oxide and 20 to 60 wt. % of propylene oxide as well as 0 to 30 wt. % of carbon dioxide, and particularly preferably 35 to 75 wt. % of ethylene oxide and 25 to 40 wt. % of propylene oxide as well as 0 to 25 wt. % of carbon dioxide, each related to the total quantity of propylene oxide and ethylene oxide as well as carbon dioxide in the polyetherpolyol or polyether carbonate polyol or in the their mixtures.

The production of the polyetherpolyols can be realised through catalytic addition of ethylene oxide and propylene oxide and possibly of one or more further alkylene oxides to one or more H-functional starter compounds. The polyether carbonate polyols to be used according to the invention can for example be obtained through catalytic conversion of ethylene oxide and propylene oxide, possible further alkylene oxides and carbon dioxide in the presence of H-functional starter substances (see for example EP-A 2046861).

The following two paragraphs apply for both compound groups independently from each other:

Further alkylene oxides (epoxides) to be used can be alkylene oxides with 2 to 24 carbon atoms. The alkylene oxides with 2 to 24 carbon atoms are for example one or more compounds selected from the group consisting of 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrol oxide, methylstyrol oxide, pinene oxide, single- or multiple epoxy-enhanced fats as mono-, di- and triglycerides, epoxy-enhanced fatty acids, C₁-C₂₄-ester of epoxy-enhanced fatty acids, epichlorohydrine, glycidol and derivatives of the glycidol, such as for example methylglycidylether, ethylglycidylether, 2-ethylhexylglycidylether, allylglycidylether, glycidylmethacrylate as well as epoxy-functional alkyoxysilanes, such as for example 3-glycidyloxypropyl-trimethoxysilane, 3-glycidyioxypropyltriethoxysilane, 3-glycidyloxypropyltripropoxysilane, 3-glycidyloxypropylmethyl-dimethoxysilane, 3-glycidyloxypropylethyldiethoxysilane, 3-glycidyloxypropyltrlisopropoxysilane. A further alkylene oxide to be used is preferably 1,2-butylene oxide. The alkylene oxides can be added to the reaction mixture individually, as part of a mixture or one after the other. These can be statistical or block copolymers. If the alkylene oxides are dosed after each other the products produced will contain (polyether (carbonate) polyol) polyether chains with block structures.

The H-functional starter compounds have functionalities of ≥2 to ≤6, preferably ≥2 to ≤4 and are preferably hydroxy-functional (OH-functional). Examples of hydroxy-functional starter compounds are propylene glycol, ethylene glycol, diethylene glycol, dipropylene glycol, 1,2-butanediol, 1,3-butanediol, 1,4-butanediol, hexanediol, pentanediol, 3-methyl-1,5-pentanediol, 1,12-dodecanediol, glycerine, trimethylolpropane, triethanolamine, pentaerythrit, sorbitol, saccharose, hydrochinon, brenzcatechine, resorcin, bisphenol F, bisphenol A, 1,3,5-trihydroxybenzol, methylol-group containing condensates of formaldehyde and phenol or melamine or urea. 1,2-propylene glycol and/or glycerine and/or trimethylolpropane and/or sorbitol are preferably used as a starter compounds.

The polymerpolyols are obtained through radical polymerisation of olefinic unsaturated monomers or mixtures of olefinic unsaturated monomers in the described polyetherpolyols. Examples of such monomers are butadiene, styrol, α-methylstyrol, methylstyrol, ethylstyrol, acrylnitrile, methacrylnitrile, methylmethacrylate, acrylic acid ester. Styrol and/or acrylnitrile are preferably used. Particularly preferred are styrol and acrylnitrile. When using styrol and acrylnitrile the ratio of these two monomers is preferably 20:80 to 80:20, in particular 70:30 to 30:70 parts by weight.

The initialisation of the radical polymerisation is realised with the usual radical-forming initiators. Example of such initiators are organic peroxides such as benzoylperoxide, tert.-butyloctoate, didesanoylperoxide, azo compounds such as azoisobutyronitrile or 2,2′-azobis(2-methylbutyronitrile).

The filler component of the polymer is 5 to 50 wt. %, preferably 10 to 40 wt. %, particularly preferably 20 to 35 wt. % (related to the mass of polymerpolyol).

The polymerpolyol has a hydroxyl value according to DIN 53240 of 10 to 100 mg KOH/g, preferably of ≥15 to ≤80 mg KOH/g and particularly preferably of ≥20 mg KOH/g to ≤60 mg KOH/g.

### Description of Component A2:

The polyesterpolyols used according to the invention are obtainable through polycondensation of one or more dicarboxylic acids A2.1 and at least one twin- and/or multi-value aliphatic alcohol A2.2, wherein the polycondensation can be carried out at least in part in the presence of a catalyst.

Component A2 preferably includes a polyester that is an at least 95 wt. % aliphatic polyester and the alcohol component A2.2 of which is selected to at least 90 wt. % from the group consisting of ethylene glycol, diethylene glycol and/or trimethylolpropane.

The polyesterpolyols A2 used have an acid value of less than 5 mg KOH/g, preferably of less than 4 mg KOH/g. This can be realised in that polycondensation is terminated when the acid value of the reaction product obtained is less than 5 mg KOH/g, preferably less than 4 mg KOH/g. The polyesterpolyols A2 used have a hydroxyl value of 40 mg KOH/g to 85 mg KOH/g, preferably of 45 to 75 mg KOH/g and a functionality of 2 to 6, preferably of 2 to 3, particularly preferably of 2.2 to 2.8.

Functionality of polyester component=number of OH end groups/number of molecules (II)

The number of molecules is obtained by deducting the moles of ester groups formed from the sum of moles of all substances. In a case where only polycarboxylic acids are used the mole value of ester groups formed equals the mole value of reaction water created. With carboxylic acid hydrides correspondingly less water is created, whilst the use of low-molecular alkyl esters will produce low-molecular alcohol instead of water.

One obtains the number of OH end groups by deducting the moles of ester groups concerted into carboxyl groups from the moles of OH groups used.

Component A2.1 includes organic dicarboxylic acids with 2 to 12, preferably 2 to 10 carbon atoms between the carboxyl groups. Suitable dicarboxylic acids are for example succinic acid, glutaric acid, adipic acid, pimelic acid, subaric acid, azelaic acid, sebacic acid, undecandic acid, dodecandic acid, tridecandic acid and/or tetradeacandic acid or their anhydrides and/or their low-molecular dialkylesters. Preferred are succinic acid, glutaric acid, adipic acid, pimelic acid, subaric acid, azelaic acid and/or sebacic acid, particularly preferably succinic acid, adipic acid, azelaic acid and sebacic acid. In component A2.1 one or more dicarboxylic acids can be included, which are produced according to a fermentative method or have a biological origin.

In addition to the said aliphatic dicarboxylic acids a quantity of up to 10 wt. % related to A2.1. of aromatic dicarboxylic acid, such as for example phthalic acid, phthalic acid anhydride, isophthalic acid, terephthalic acid and/or their dialkylesters can be used.

Component A2.2 includes two- and/or multi-value aliphatic alcohols and/or polyether alcohols with a molecular mass of ≥62 g/mol to ≤400 g/mol. These for example include 1,4-dihydroxycyclohexane, 1,2-propanediol, 1,3-propanediol, 2-methylpropanediol-1,3, 1,5-pentanediol, 1,6-hexanediol, 1,8-octanediol, neopentyl glycol, ethylene glycol, diethylene glycol, triethylene glycol, tetraethylene glycol, dipropylene glycol, tripropylene glycol, dibutylene glycol, tripropylene glycol, glycerine, pentaerythrit and/or trimethylolpropane. Preferred are here neopentyl glycol, diethylene glycol, triethylene glycol, trimethylolpropane and/or glycerine, particularly preferably ethylene glycol, diethylene glycol and/or trimethylolpropane.

The said alcohols have boiling points at which a discharge together with reaction water can be avoided and have no tendency towards unwelcome side reactions at the usual reaction temperatures either.

The polyester condensation can be carried out with or without suitable catalysts, which are known to the person skilled in the art.

The ester condensation reaction can be carried out at reduced pressure and increased temperature with a simultaneous destillative removal of the water or low-molecular alcohol generated during the condensation reaction. It can also be completed according to the azeotropic method in the presence of an organic solvent such as toluol as an entrainer or according to the carrier gas method, i.e. by driving out any water generated with an inert gas such as nitrogen or carbon dioxide.

The reaction temperature of the polycondensation is preferably ≥150° C. to ≤250° C. The temperature can also lie within a range of ≥180° C. to ≤230° C.

In addition to components A1 and A2, component A can include further compounds A3 that are capable of reacting with isocyanate groups. These are compounds with at least two hydrogen atoms capable of reacting with isocyanates and a molecular weight of 32 to 399. They should be understood as hydroxyl group and/or amino group and/or thiol group and/or carboxyl group comprising compounds, preferably hydroxyl group and/or amino group comprising compounds, which serve as chain extension agents or cross-linking agents. These compounds normally have 2 to 8, preferably 2 to 4, hydrogen atoms capable of reacting with isocyanates. Ethanolamine, diethanolamine, triethanolamine, sorbitol and/or glycerine can for example be used. Further examples are described in EP-A 0 007 502, pages 16-17.

### Description of Component B

Aliphatic, cycloaliphatic, araliphatic, aromatic and heterocyclic polyisocyanates such as for example those described by W. Siefken in Justus Liebigs Annalen der Chemie, 562, pages 75 to 136 are used as component B, for example those with the formula (I)

Q(NCO)ₙ (I)

in which
n=2-4, preferably 2-3,
and
Q means an aliphatic hydrocarbon rest with 2-18, preferably 6-10 C atoms, a cycloaliphatic hydrocarbon rest with 4-15, preferably 6-13 C atoms or an araliphatic hydrocarbon rest with 8-15, preferably 8-13 C atoms.

These are for example polyisocyanates like those described in EP-A 0 007 502, pages 7-8. Particularly preferably the normally technically easily accessible polyisocyanates, for example 2,4- and 2,6-toluylenediisocyanate as well as any other mixtures of these isomers (“TDI”), polyphenylpolymethylenepolyisocyanates like those produced through aniline-formaldehyde condensation and subsequent phosgenation (“raw MDI”) and carbodiimide group, urethane group, allophanate group, isocyanurate group, urea group or biuret group comprising polyisocyanates (“modified polyisocyanates”), in particular those modified polyisocyanates deduced from 2,4- and/or 2,6-toluylenediisocyanate or from 4,4′- and/or 2,4′-diphenylmethanediisocyanate. Preferably used as component B is at least one compound selected from the group consisting of 2,4- and 2,6-toluylenediisocyanate, 4,4′- and 2,4′- and 2,2′-diphenylmethanediisocyanate and polyphenylpolymethylenepolyisocyanate (“multi-core MDI”).

The index (isocyanate index) provides the ratio of the isocyanate quantity actually used to the stoichiometric, i.e. calculated isocyanate group (NCO) quantity:

Index=[(isocyanate quantity used):(isocyanate quantity calculated)]·100 (II)

The production of the polyurethane foam according to the invention is realised at an index of between 75 to 120, preferably of 85 to 115.

### Description of Component D

Carbon dioxide and/or readily volatile organic substances such as for example dichloromethane are used as a physical propellant.

### Description of Component E

Used as component E are possibly excipients and additives such as
a) catalysts (activators),
b) surfactant additives (tensides) such as emulsifiers and foam stabilisers,
c) one or more additives selected from the group consisting of reaction inhibitors (for example acidically reacting substances such as hydrochloric acid or organic acid halogenides), cell regulators (such as for example paraffins or fatty alcohols or dimethylpolysiloxanes), pigments, dyes, flame retardants (such as for example tricresylphosphate), stabilisers against ageing and weathering influences, softeners, fungistatically and bacteriostatically acting substances, fillers (such as for example barium sulfate, diatomaceous earth, carbon black or precipitide chalk) and separating agents.

These excipients and additives that may also be used are for example described in EP-A 0 000 389, pages 18-21. Further examples of excipients and additives that can also be used as well as details of applications and modes of action of these excipients and additives are described in Kunststoff-Handbuch, vol. VII, published by G. Oertel, Carl-Hanser-Verlag, Munich, issue 3, 1993, for example on pages 104-127.

The following are preferably used as catalysts: aliphatic tertiary amines (for example trimethylamine, tetramethylbutanediamine, 3-dimethylaminopropylamine, N,N-bis(3-dimethylaminopropyl)-N-isopropanolamine), cycloaliphatic tertiary amines (for example 1,4-diaza(2,2,2)bicyclooctane), aliphatic aminoether (for example bisdimethylaminoethylether, 2-(2-dimethylaminoethoxy)ethanol and N,N,N-trimethyl-N-hydroxyethyl-bisaminoethylether), cycloaliphatic aminoether (for example N-ethylmorpholine), aliphatic amidines, cycloaliphatic amidines, urea and derivatives of urea (such as for example aminoalkyl urea, see for example EP-A 0 176 013, in particular (3-dimethylaminopropylamine) urea).

Catalysts used can also be salts of tin (II) of carboxylic acids, wherein the respective underlying carboxylic acid preferably has 2 to 20 carbon atoms. Particularly preferred are the salt of tin (II) of 2-ethylhexane acid (i.e. tin (II)-(2-ethylhexanoate)), the salt of tin (II) of 2-butyloctane acid, the salt of tin (II) of 2-hexyldecane acid, the salt of tin (II) of neodecanoic acid, the salt of tin (II) of oleic acid, the salt of tin (II) of ricinoleic acid and tin (II) laureate. Tin (IV) compounds, such as for example dibutyl tin oxides, dibutyl tin dichloride, dibutyl tin diacetate, dibutyl tin dilaureate, dibutyl tin maleate or dioctyl tin acetate can also be used as catalysts. All of the said catalysts can of course also be used as mixtures.

### Carrying Out the Method for Producing Flexible Polyester Urethane Foams

The production of foams on an isocyanate basis is known in itself and is for example described in DE-A 1 694 142, DE-A 1 694 215 and DE-A 1 720 768 as well as in Kunststoff-Handbuch vol. VII, polyurethane, published by Vieweg and Höchtlein, Carl Hanser Verlag Munich 1966, as well as in the new edition of this book, published by G. Oertel, Carl Hanser Verlag Munich, Vienna 1993.

The polyurethane foams can be produced according to various block foam production methods or also in moulds. The reaction components are brought to conversion according to the grading method that is known in itself, the prepolymer method or the semi-prepolymer method for carrying out the method according to the invention, wherein one preferably uses machine equipment as described in U.S. Pat. No. 2,764,565.

During foam production the foaming can also be realised in closed moulds according to the invention. For this the reaction mixture is placed into a mould. The mould material can for example be aluminium or plastic, for example epoxy resin. The foamable reaction mixture foams up in the mould and forms the moulded body. Mould foaming can be carried out in such a way here that the moulded body has a cell structure on its surface. It can however also be carried out in a way that the moulded body has a compact skin and a cell-like core. According to the invention one can approach in such a way in this regard that one places so much reaction mixture into the mould that the foam created just fills the mould. One can however also work in such a way that one places more foamable reaction mixture in the mould than is necessary for filling the mould interior with foam. In the latter case one would thus work according to the so-called “overcharging” principle; such an approach is known from U.S. Pat. No. 3,178,490 and U.S. Pat. No. 3,182,104.

During mould foaming “external separating agents” known in themselves, such as silicone oils, are also often used. One can however also used so-called “internal separating agents”, possibly as a mixture with external separating agents, as is for example clear from DE-OS 21 21 670 and DE-OS 23 07 589.

The polyurethane foams are preferably produced in blocks by means of continuous foaming.

The method according to the invention is preferably used for producing flexible polyurethane foams with a raw density (also known as bulk density) of 18 kg m⁻³ to 80 kg m⁻³, particularly preferably of 20 kg m⁻³ to 70 kg m⁻³.

The flexible polyester urethane foams obtainable according to the method of the invention are also object of the present invention.

### EXAMPLES

Polyol A1: polymerpolyol with 31% filler, produced by means of in-situ polymerisation of styrol and acrylnitrile (ratio 40:60) in a polyetherpolyol with a mole mass of 2000, calculated functionality of 2.0 and a ratio of ethylene oxide and propylene oxide of 50/50. The polymerpolyol obtained in this way had a hydroxyl value of 38 mg KOH/g and a viscosity of 4625 mPa·s at 25° C.

Polyol A2: polyesterpolyol on a basis of trimethylolpropane, diethylene glycol and adipic acid with a hydroxyl value of 60 mg KOH/g, available as Desmophen® 2200 B (Bayer MaterialScience AG, Leverkusen)

A5-1 (stabiliser): siloxane-based foam stabiliser Tegostab® B 8324, (Evonik Goldschmidt GmbH, Essen)

A5-2 (stabiliser): siloxane-based foam stabiliser Tegostab® B 8301, (Evonik Goldschmidt GmbH, Essen)

Isocyanate B-1: mixture of 80 wt. % 2,4- and 20 wt. % 2,6-toluylene diisocyanate, available under the name Desmodur® T 80, (Bayer MaterialScience AG, Leverkusen)

A5-3 (catalyst): Niax® A 30, amine catalyst, (Momentive Performance Materials GmbH, Leverkusen)

A5-4 (catalyst): Addocat® 117, amine catalyst, (Rhein Chemie Rheinau GmbH, Mannheim)

Viscosity was determined according to DIN 53019 at a shear rate of 5 s⁻¹.

The hydroxyl value was determined according to DIN 53240.

Polyurethane foams were produced according to the recipes listed in the following table.

Listed are the component proportions in parts by weight.

The raw density and compression hardness were determined according to DIN EN ISO 3386-1.

TABLE 1
Flexible polyurethane foams

| | Example | | | |
|---|---|---|---|---|
| | | | 3 | |
| | 1 | 2 | (comp.) | 4 (comp.) |
| A2 | 90 | 70 | 100 | 30 |
| A1 | 10 | 30 | — | 70 |
| A5-1 | 0.40 | 0.40 | 0.40 | 0.40 |
| A5-2 | 0.80 | 0.25 | 0.25 | 0.25 |
| A5-3 | 0.25 | 0.25 | 0.25 | 0.25 |
| A5-4 | 0.25 | 0.25 | 0.25 | 0.25 |
| A3 (water) | 4.50 | 4.50 | 4.50 | 4.50 |
| Isocyanate B-1 | 52.6 | 51.9 | 53.0 | 50.6 |
| NCO index | 100 | 100 | 100 | 100 |
| Raw density [kg m⁻³] | 24.6 | 26.4 | 24.9 | Foam |
| | | | | collapse |
| Compression hardness at 40% | 6.4 | 8.0 | 6.0 | — |
| Deformation [kPa] | | | | |

Examples 1 and 2 are examples according to the invention, whilst examples 3 and 4 are comparison examples. The results show that foams with increased compression hardness compared to foam according to example 3 are obtained when using the polymerpolyols of type A1 as per the invention and an otherwise identical recipe and the same NCO index. Example 4 shows that the use of an excessive proportion of polymerpolyol of type A1 is not suitable for producing foams.

1: A method for producing flexible polyester urethane foams, obtainable by reacting
A) an isocyanate-reactive component comprising
A1) 1 to 60 wt. % of a polymerpolyol component comprising at least one polymerpolyol with a hydroxyl value of 10 to 100 mg KOH/g, which contains as a filler 5 to 50 wt. % of a polymer and as a base polyol at least one polyetherpolyol and/or at least one polyether carbonate polyol with an ethylene oxide proportion of 30 to 90 wt. %, a propylene oxide proportion of 10 to 70 wt. % and a carbon dioxide proportion of 0 to 35 wt. %, based on 100 wt. % of propylene oxide, ethylene oxide and carbon dioxide in the polyetherpolyol or polyethercabonatepolyol or in their mixtures,
and
A2) 40 to 99 wt. % of a polyesterpolyol component comprising at least one polyesterpolyol with a hydroxyl value of 30 to 90 mg KOH/g,
and, optionally,
A3) one or more components having groups capable of reacting with isocyanates, wherein components A3) differ from A1 and A2;
with
B) one or more di- and/or polyisocyanates,
C) water,
and, optionally,
D) physical propellants,
and, optionally,
E) excipients and additives.

2: The method according to claim 1, wherein component A) contains 5 to 50 wt. % of component A1); and 50 to 95 wt. % of component A2).

3: The method according to claim 1, wherein the polyetherpolyols used as a base polyol and the polyether carbonate polyols include a proportion of 40 to 80 wt. % of ethylene oxide and of 20 to 60 wt. % of propylene oxide and of 0 to 30 wt. % of carbon dioxide, based on 100 wt. % of propylene oxide, ethylene oxide and carbon dioxide in the polyetherpolyol or polyether carbonate polyol or in their mixtures.

4: The method according to claim 1, wherein the polyetherpolyols used as the base polyol and the polyether carbonate polyols have a hydroxyl value according to DIN 53240 of ≥20 mg KOH/g to ≤250 mg KOH/g.

5: The method according to claim 1, wherein the filler polymer is obtainable through radical polymerisation of styrol, α-methylstyrol, methylstyrol, ethylstyrol, acrylnitrile, methacrylnitrile, methylmethacrylate, acrylic acid ester or mixtures of these monomers.

6: The method according to claim 5, wherein styrol and acrylnitrile are used at a ratio of 20:80 to 80:20 parts by weight.

7: The method according to claim 1, wherein the filler content of the polymer is 10 to 40 wt. %, (related to the mass of polymerpolyol).

8: The method according to claim 1, wherein the polymerpolyol has a hydroxyl value according to DIN 53240 of ≥15 to ≤80 mg KOH/g.

9: The method according to claim 1, wherein at least 95 wt. % of component A2 is an aliphatic polyester.

10: The method according to claim 1, wherein at least 90 wt. % of the alcohol component of the polyester A2 is based on twin- and/or multi-value aliphatic alcohols and/or polyether alcohols with a molecular mass of ≥62 g/mol to ≤400 g/mol.

11: The method according to claim 1, wherein at least 90 wt. % of the alcohol component of the polyester A2 consists of 1,4-dihydroxycyclohexane, 1,2-propanediol, 1,3-propanediol, 2-methylpropanediol-1,3, 1,5-pentanediol, 1,6-hexanediol, 1,8-octanediol, neopentyl glycol, ethylene glycol, diethylene glycol, triethylene glycol, tetraethylene glycol, dipropylene glycol, tripropylene glycol, dibutylene glycol, tripropylene glycol, glycerine, pentaerythrite and/or trimethylolpropane, preferably at least 90 wt. % of neopentyl glycol, diethylene glycol, triethylene glycol, trimethylolpropane and/or glycerine.

12: The method according to claim 1, wherein the carboxylic acid component of the polyester A2 is based on organic dicarboxylic acids with 2 to 12.

13: The method according to claim 1, wherein the carboxylic acid component of the polyester A2 consist to at least 90 wt. % of aliphatic dicarboxylic acid.

14: The method according to claim 1, wherein the polyesterpolyol component A2 has an acid value of less than 5 mg KOH/g, a hydroxyl value of 40 mg KOH/g to 85 mg KOH/g, and a functionality of 2 to 6.

15: Flexible polyester urethane foam obtainable with a method according to claim 1.

16: The method according to claim 2, wherein component A) contains 10 to 40 wt. % of component A1); and 60 to 90 wt. %. of component A2).

17: The method according to claim 3, wherein the polyetherpolyols used as a base polyol and the polyether carbonate polyols include a proportion of 35 to 75 wt. % of ethylene oxide and of 25 to 40 wt. % of propylene oxide and of 0 to 25 wt. % of carbon dioxide, based on 100 wt. % of propylene oxide, ethylene oxide and carbon dioxide in the polyetherpolyol or polyether carbonate polyol or in their mixtures.

18: The method according to claim 4, wherein the polyetherpolyols used as the base polyol and the polyether carbonate polyols have a hydroxyl value according to DIN 53240 of ≥20 to ≤112 mg KOH/g

19: The method according to claim 4, wherein the polyether polyols used as the base polyol and the polyether carbonate polyols have a hydroxyl value according to DIN 53240 of ≥20 mg KOH/g to ≤80 mg KOH/g.

20: The method according to claim 5, wherein styrol and acrylnitrile are used at a ratio of 30:70 to 70:30 parts by weight.

21: The method according to claim 1, wherein E) said excipients and/or additives comprise at least one of catalysts, surfactant additives, reaction inhibitors, cell regulators, pigments, dyes, flame retardants, softeners, fungiastatically and/or bacteriostatically acting substances, fillers and separating agents.
